(19) United States
(12) Patent Application Publication
(10) Pub. No.: US 2015/0130437 A1
(43) Pub. Date: May 14, 2015

(54) DC-DC CONVERTER

(71) Applicant: KABUSHIKI KAISHA TOSHIBA, Minato-ku (JP)

(72) Inventor: Naoto SHINOHARA, Kawasaki (JP)

(73) Assignee: KABUSHIKI KAISHA TOSHIBA, Minato-ku (JP)

(21) Appl. No.: 14/525,789

(22) Filed: Oct. 28, 2014

(30) Foreign Application Priority Data
Nov. 13, 2013 (JP) 2013--235005

(51) Int. Cl. H02M 1/34; H02M 3/156

(52) U.S. Cl. CPC H02M 1/34; H02M 3/156; H02J 2001/008
USPC 323/282

(57) ABSTRACT

A DC-DC converter includes a main reactor disposed in a main energization path, a first main switching element disposed in the main energization path and on-off controlled to cause current flowing through the main reactor to intermittently flow, a second main switching element forming a discharge loop configured to discharge electrical energy stored in the main reactors to the DC voltage output terminal side, an auxiliary reactor disposed between the first main switching element and the main reactor, an auxiliary switching element discharging electrical energy stored in the reactors through the main reactor to the DC voltage output terminal side in the main energization path, diodes connected reversely in parallel to the respective main switching elements and the auxiliary switching element, and a series circuit connected in parallel to the auxiliary reactor and including a diode with an anode located at the main reactor side and a capacitor.

### CROSS-REFERENCE TO RELATED APPLICATIONS

This application is based upon and claims the benefit of priority from the prior Japanese Patent Application No. 2013-235005 filed on Nov. 13, 2013, the entire contents of which are incorporated herein by reference.

### FIELD

Embodiments described herein relate to a DC-DC converter converting a DC voltage to another DC voltage having a different value.

### BACKGROUND

A DC-DC converter has a function of converting a DC voltage to another DC voltage having a different value by stepping down or up the DC voltage output from a DC power supply and a function of DC stabilized power supply by addition of feedback control and PWM control. The DC-DC converter is normally configured as a DC chopper circuit comprised of two switching elements, a single reactor and a free-wheeling diode. The first and second switching elements are series-connected between positive and negative terminals of a DC power supply. The reactor is connected via a load in parallel to the second switching element located at the negative side.

Snubber diodes or free-wheeling diodes are connected in parallel to the switching elements respectively. The first and second switching elements are on-off controlled alternately. DC current is supplied from the DC power supply via the reactor to a load while the first switching element is turned on. When the first switching element is turned off, electric energy by back electromotive force is stored in the reactor.

The above-mentioned stored energy causes electrical current to circulate in a closed loop which is formed when the second switching element is turned on alongside turn-off of the first switching element, so that the stored energy is discharged as DC current to the load. Since the first and second switching elements are series-connected between the positive and negative terminals of the DC power supply in the above-described DC-DC converter, a short-circuit current flows through both switching elements, which break down when there is a time period in which the switching elements are simultaneously turned on. For the purpose of preventing breakdown, both switching elements are controlled to be turned on and off with a dead time that is a time zone in which both switching elements are turned off.

Occurrence of short-circuit current also results from a recovery current, other than the above-described cause which can be prevented by application of the dead time. A technique has been proposed which reduces occurrence of recovery current in resonance type DC-DC converters. The recovery current is an instantaneous large current flowing in a reverse direction through the snubber diode or free-wheeling diode connected in reversely parallel to the switching elements as described above. Reverse voltage is applied to the diode when the switching element is turned off, and residual carriers stored in the diode causes reverse current to flow instantaneously. When recovery current short-circuits the paired series-connected switching elements configuring the DC chopper circuit, the DC output voltage fluctuates or noise is radiated.

The short-circuit current caused by the recovery current has a sharp impulse waveform thereby to bring large surge voltage, resulting in rushing noise. For example, when the DC-DC converter is mounted on a vehicle, the above-mentioned surge voltage results in various malfunctions, for example, the surge voltage varies a body chassis potential, enlarges control error and increases switching loss. The DC-DC converter of the above-described type is also used as a DC power supply circuit for portable electrical equipment. Elimination of malfunctions resulting from short-circuit current is strongly desired with progress in reductions in size and power consumption.

### BRIEF DESCRIPTION OF THE DRAWINGS

FIG. 1 is a circuit diagram showing a DC-DC converter according to a first embodiment;

FIGS. 2A to 2I are schematic graphs showing voltage and current waveforms;

FIG. 3 is a circuit diagram showing the DC-DC converter according to a second embodiment;

FIGS. 4A to 4J are schematic graphs showing voltage and current waveforms;

FIG. 5 is a circuit diagram showing the DC-DC converter according to a third embodiment;

FIG. 6 is a circuit diagram showing the DC-DC converter according to a fourth embodiment;

FIG. 7 is a circuit diagram showing the DC-DC converter according to a fifth embodiment; and

FIGS. 8A to 8K are schematic graphs showing voltage and current waveforms.

### DETAILED DESCRIPTION

In general, according to one embodiment, a DC-DC converter includes a main reactor disposed in a main energization path extending from a DC voltage input terminal to a DC voltage output terminal. A first main switching element is disposed in the main energization path and on-off controlled to cause current flowing through the main reactor to intermittently flow. A second main switching element forms a discharge loop configured to discharge electrical energy stored in the main reactors to the DC voltage output terminal side. An auxiliary reactor is disposed between the first main switching element and the main reactor in the main energization path. An auxiliary switching element discharges electrical energy stored in the auxiliary and main reactors through the main reactor to the DC voltage output terminal side in the main energization path. A plurality of diodes is connected reversely in parallel to the respective main switching elements and the auxiliary switching element. A series circuit is connected in parallel to the auxiliary reactor and includes a diode with an anode located at the main reactor side and a capacitor.

According to another embodiment, a DC-DC converter includes a positive input terminal and a negative input terminal and a positive output terminal and a negative output terminal. A first main switching element and an auxiliary switching element are connected in series to each other between the positive input terminal and the negative input terminal and located at the positive and negative sides respectively. A main reactor has one of two ends connected to the positive output terminal and an auxiliary reactor has one of two ends connected to the other end of the main reactor. The other end of the auxiliary reactor is connected to a common node of both switching elements. A second main switching element is connected between a common node of the reactors and the negative output terminal. A plurality of diodes is connected reversely in parallel to the respective main switching elements and the auxiliary switching element. A series circuit is connected in parallel to the auxiliary reactor and including a diode with an anode located at the main reactor side and a capacitor.

According to further another embodiment, a DC-DC converter includes a positive input terminal and a negative input terminal and a positive output terminal and a negative output terminal. A first and a second main switching elements are series-connected between the positive input terminal and the negative input terminal. A main reactor is connected between a common node of both main switching elements and the positive output terminal. A first and a second auxiliary switching elements are series connected between the positive input terminal and the negative input terminal. An auxiliary reactor is connected between a common node of the first and second main switching elements and a common node of the first and second auxiliary switching elements. A plurality of diodes is connected in reversely parallel to the respective main switching elements and the respective auxiliary switching elements. A series circuit is connected in parallel to the auxiliary reactor and including a diode with an anode located at the main reactor side and a capacitor.

According to still further another embodiment, a DC-DC converter includes a main reactor disposed in a main energization path extending from a DC voltage input terminal to a DC voltage output terminal. A first main switching element is disposed in the main energization path and on-off controlled to cause current flowing through the main reactor to intermittently flow. A second main switching element forms a discharge loop configured to discharge electrical energy stored in the main reactor to the DC voltage output terminal side. An auxiliary reactor is disposed between the first main switching element and the main reactor in the main energization path. An auxiliary switching element discharges electrical energy stored in the auxiliary and main reactors through the main reactor to the DC voltage output terminal side in the main energization path. A plurality of diodes is connected in reversely parallel to the respective main switching elements and the auxiliary switching element. A power consumption circuit is series-connected between a common node of the auxiliary reactor and the main reactor and ground and includes a diode with an anode located at the common node side, a capacitor and a power consumption element connected in parallel to the capacitor.

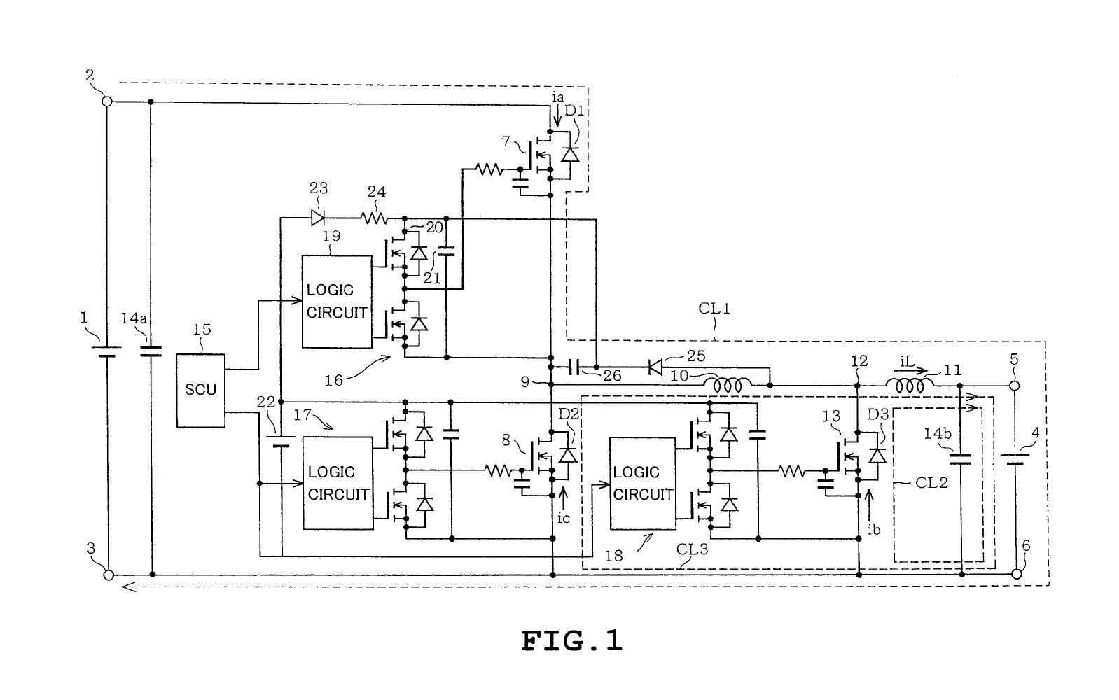

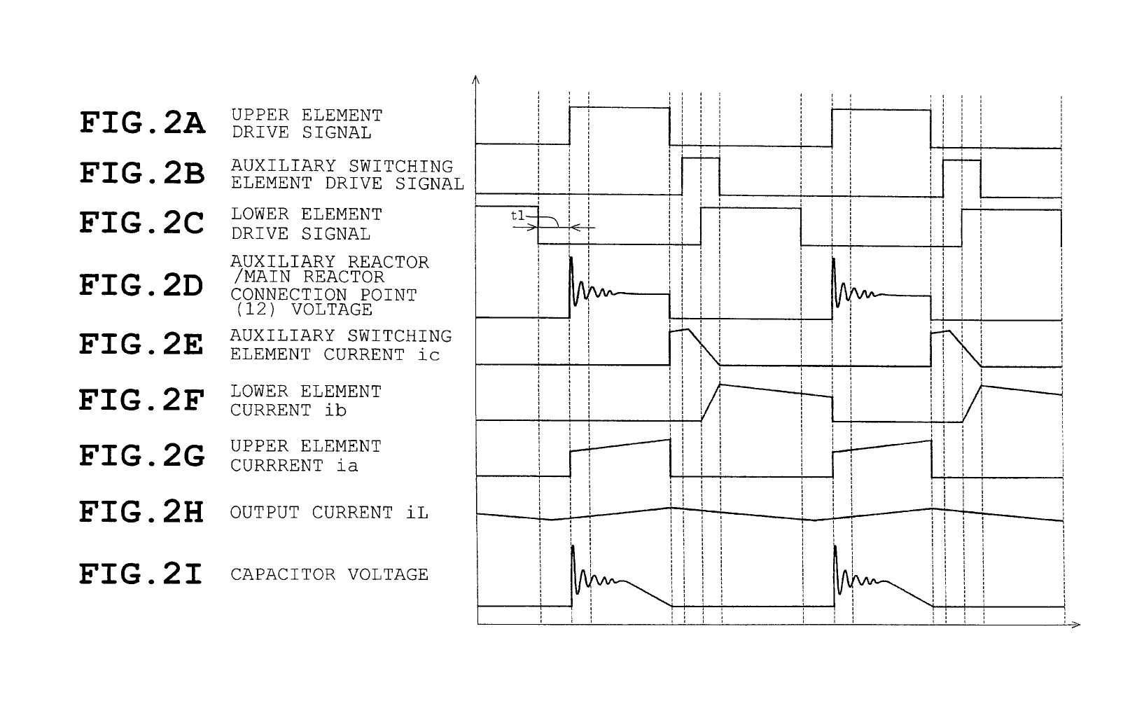

A first embodiment will be described with reference to FIGS. 1 and 2A to 2I. Referring to FIG. 1, a DC-DC converter includes an input side in which are provided a positive input terminal 2 and a negative input terminal 3 (DC voltage input terminals) both connected to a DC power supply 1. The DC-DC converter also includes an output side in which are provided a positive output terminal 5 and a negative output terminal 6 (DC voltage output terminals) both connected to a load 4. The positive and negative sides relatively indicate potential levels. The DC power supply 1 is a DC power supply including a battery and an AC-DC conversion and rectification circuit or the like. The load 4 indicated by a symbol of DC power supply includes a resistance load, an induction load such as an electric motor, a charged battery or the like.

A series circuit of a first main switching element 7 and an auxiliary switching element 8 is connected between the positive and negative input terminals 2 and 3. A series circuit of an auxiliary reactor 10 and a main reactor 11 is connected between a common node 9 of the switching elements 7 and 8 and the positive output terminal 5. A second main switching element 13 is connected between a common node 12 of reactors 10 and 11 and the negative output terminal 6. A smoothing capacitor 14a is connected between the positive and negative input terminals 2 and 3. Another smoothing capacitor 14b is connected between the positive and negative output terminals 5 and 6.

Three diodes D1, D2 and D3 are connected in reverse parallel to the switching elements 7, 8 and 13 respectively. In the embodiment, the switching elements 7, 8 and 13 are N-channel MOSFETs respectively, and the diodes D1 to D3 are parasitic diodes of the MOSFETs respectively. However, the switching elements may be elements, such as bipolar transistors, having no parasitic diodes. In this case, the diodes D1, D2 and D3 have outer portions connected to one another.

The auxiliary reactor 10 has an inductance that is, for example, about 1/100 of one of the main reactor 11. The auxiliary reactor 10 may have a smaller current capacitance than the main reactor 11 (for example, 75% or below). The auxiliary switching element 8 may also have a smaller current capacitance than the first main switch 7.

A switching control unit (SCU) 15 is configured of a microcomputer and outputs gate control signals to the switching elements 7, 8 and 13 to on-off control these switching elements. The gate switching signals are supplied via gate drive circuits 16 to 18 to gates of the switching elements 7, 8 and 13 respectively. The gate drive circuits 16 to 18 are circuits applying gate voltage of 15 volts to sources when N-channel MOSFETs are used as the switching elements 7, 8 and 13, for example.

The gate drive circuits 16 to 18 include logic circuits 19, pre-drivers 20 including series circuits of two N-channel MOSFETs and smoothing capacitors 21 connected in parallel to the pre-drivers 20, respectively (only components of the gate drive circuit 16 are labeled by these reference symbols). Power from a voltage source 22 is directly supplied to the gate drive circuits 17 and 18 as a driving power. The power from the voltage source 22 is also supplied via the diode 23 and a resistive element 24 to the gate drive circuit 16.

The N-channel MOSFETs configuring the pre-driver 20 are on-off controlled by signals output from the logic circuit 19 in an exclusive manner. A source voltage of the switching element 7 changes to a negative side voltage and a positive side voltage of the DC power supply 1 by a switching operation. The pre-driver 20 is configured of, for example, a bootstrap circuit or the like so as to follow switching voltage. However, the pre-driver 20 may be configured of a flyback converter, instead.

The gate drive circuits 16 to 18 have output terminals connected via resistive elements to gates of the switching elements 7, 8 and 13 respectively. Further, capacitors are connected between gates and sources of the switching elements 7, 8 and 13 respectively. The capacitors are connected as output loads of the gate drive circuits 16 to 18 together with the resistive elements and parasitic capacities present between the gates and the sources, respectively.

A series circuit of a diode 25 and a capacitor 26 is connected in parallel to the auxiliary reactor 10. The diode 25 has an anode connected to the common node 12 and a cathode connected to a common node of the resistive element 24 and the smoothing capacitor 21.

In the above-described configuration, the auxiliary reactor 10 and the main reactor 11 are interposed in a main energization path extending from the positive input terminal 2 to the positive output terminal 5. When current flowing through the auxiliary reactor 10 and the main reactor 11 is caused to flow intermittently by the main switching element 7 interposed in the main energization path, the intermittent current generates back electromotive force in both reactors 10 and 11, whereupon electrical (electromagnetic) energy is stored in the reactors 10 and 11. The electrical energy stored in the main reactor 11 is discharged toward the positive output terminal 5 when the second main switching element 13 is turned on. Further, when the auxiliary switching element 8 is turned on, the electrical energy stored in the auxiliary reactor 10 is discharged via the main reactor 11 to the positive output terminal 5 side, and the capacitor 21 serving as a drive voltage source of the switching element 7 is charged with the electrical energy stored in the auxiliary reactor 10 via the diode 25.

The above-described operation will be explained in more detail with reference to FIGS. 2A to 21. The first main switching element 7 (an upper element drive signal) and the second main switching element 13 (a lower element drive signal) are on-off controlled alternately, so that both switching elements 7 and 13 show an inverse correlation between gate control signals, as shown in FIGS. 2A and 2C. However, in order that simultaneous turn-on of both main switching elements 7 and 13 may be avoided, a dead time t1 which is a period during which both elements 7 and 13 are simultaneously turned off is provided before and after turn-on and turn-off of the first main switching element 7.

Upon turn-on of the first main switching element 7, a closed loop CL1 is formed so that DC current flows to the load 4 side via the first main switching element 7, the auxiliary reactor 10 and the main reactor 11, as shown in FIG. 1. FIG. 2H shows current iL flowing via the main reactor 11 in this case. The current iL is gradually increased by self-induction in a turn-on period of the first main switching element 7, so that electrical energy is stored as back electromotive force in the main reactor 11.

When the second main switching element 13 is turned on after turn-off of the first main switching element 7, a closed loop (discharge loop) CL2 is formed by the second main switching element 13, the main reactor 11 and the load 4. The electrical energy stored in the main reactor 11 then flows as current ib through the loop CL2 (see FIG. 2F) to be discharged to the load 4. Thus, the DC voltage is continuously applied to the load 4 by on-off controlling the first and second main switching elements 7 and 13. FIG. 2G shows current is flowing via the first main switching element 7 in this operation.

In parallel with the operation, the auxiliary switching element 8 is on-off controlled prior to the second main switching element 3 as shown as auxiliary switching element signal in FIG. 2B. Upon turn-on of the auxiliary switching element 8, a closed loop (discharge loop) CL3 is formed by the auxiliary switching element 8, the auxiliary reactor 10, the main reactor 11 and the load 4. When the first main switching element 7 is turned on, electrical energy stored in the auxiliary reactor 10 is discharged through the main reactor 11 to the load 4 in the closed loop CL3. FIG. 2E shows current is flowing via the auxiliary switching element 8 in this case.

The following will describe the operation to suppress short-circuit current resulting from recovery current. Reverse bias voltage is applied to the diodes D1 and D2 immediately upon turn-off of the main switching elements 7 and 13, so that the diodes D1 and D2 are about to be turned off. However, residual carrier components are present in the diodes D1 and D2. Accordingly, current due to the recovery current flows through a path from the positive input terminal 2 through the diode D1, the auxiliary reactor 10 and the diode D3 into the negative input terminal 3 in a period in which both main switching elements 7 and 13 are turned off (dead time t1 in FIG. 2C).

However, the short-circuit current due to the recovery current is reduced in the embodiment since the auxiliary reactor 10 is provided in the above-mentioned path. As a result, various failures caused by the recovery current can be eliminated. Further, the electrical energy stored in the auxiliary reactor 10 is discharged as the current ic to the load 4 upon turn-on of the auxiliary switching element 8 and consumed as energy by the load 4 thereby to be re-used. This leads to energy saving in that switching loss is compensated for. Further, the auxiliary switching element 8 and the auxiliary reactor 10 may be elements having a small current capacity and in particular, the auxiliary reactor 10 has a small inductance, as described above. Accordingly, the auxiliary reactor 10 has a compact structure such that a core is disposed along copper plates wired on the substrate.

Further, current ic is caused to flow in the period of turn-on of the auxiliary switching element 8 so that electrical energy stored in the auxiliary reactor 10 and the main reactor 11 is discharged, as shown in FIGS. 2B and 2E. Electrical power that can be discharged in this period changes depending upon impedances of the reactors 10 and 11 and the load 4. Accordingly, when a case is assumed where no series circuit of the diode 25 and the capacitor 26 is provided, not all the electrical energy stored in the auxiliary reactor 10 can be sometimes discharged.

However, since the above-described series circuit is provided in the embodiment, a path is formed which regenerates the electrical energy caused in the auxiliary reactor 10 as the power supply of the gate drive circuit 16. This causes the following action. As shown in FIGS. 2A, 2D and 2G, the current is flows into the auxiliary reactor 10 and the electrical energy is generated in synchronization with turn-on of the first main switching element 7, resulting in ringing at the common node 12. When a surge voltage due to the ringing rises to or above voltage obtained by adding forward voltage Vf of the diode 26 to the power supply voltage of the gate drive circuit 16, electrical current flows via the diode 25 to the power supply side with the result that a regenerative action is caused. Electrical energy generated in the auxiliary reactor 10 is consumed (absorbed) at this time. Accordingly, when the auxiliary switching element 8 is thereafter turned on so that current is is caused to flow, a sufficient amount of residual electrical energy can be consumed.

In the above-described embodiment, the main reactor 11 and the main switching element 7 are disposed in the main energization path from the positive input terminal 2 to the positive output terminal 5. The SCU 15 on-off controls the first main switching element 7 so that current is intermittently supplied to the main reactor 11. The second main switching element 13 forms the discharge loop CL2 through which electrical energy stored in the main reactor 11 is discharged to the DC voltage output terminal side.

Further, the auxiliary reactor 10 is disposed between the first main switching element 7 and the main reactor 11 in the main energization path, so that electrical energy stored in the auxiliary reactor 10 and the main reactor 11 is discharged via the main reactor 11 to the positive output terminal 5 side by the auxiliary switching element 8. The series circuit including the diode 25 and the capacitor 26 both having respective anodes located at the main reactor 11 side is connected in parallel to the auxiliary reactor 10, and the cathode of the diode 25 is connected to the power supply of the gate drive circuit 16. Further, the SCU 15 turns off the auxiliary switching element 8 prior to turn-on of the second main switching element 13 and turns off the auxiliary switching element 8 prior to turn-off of the second main switching element 13.

Accordingly, in synchronization with turn-on of the first main switching element 7, electrical energy generated as the result of flow of current is into the auxiliary reactor 10 can be regenerated at the power supply side of the gate drive circuit 16 and consumed. Thereafter, when the auxiliary switching element 8 is turned on so that current is is caused to flow, a sufficient amount of electrical energy remaining in the auxiliary reactor 10 can be consumed. This can eliminate the necessity to determine the inductance of the auxiliary reactor 10 in consideration of a time constant of on-off period of the first main switching element 7, rendering element selection easier.

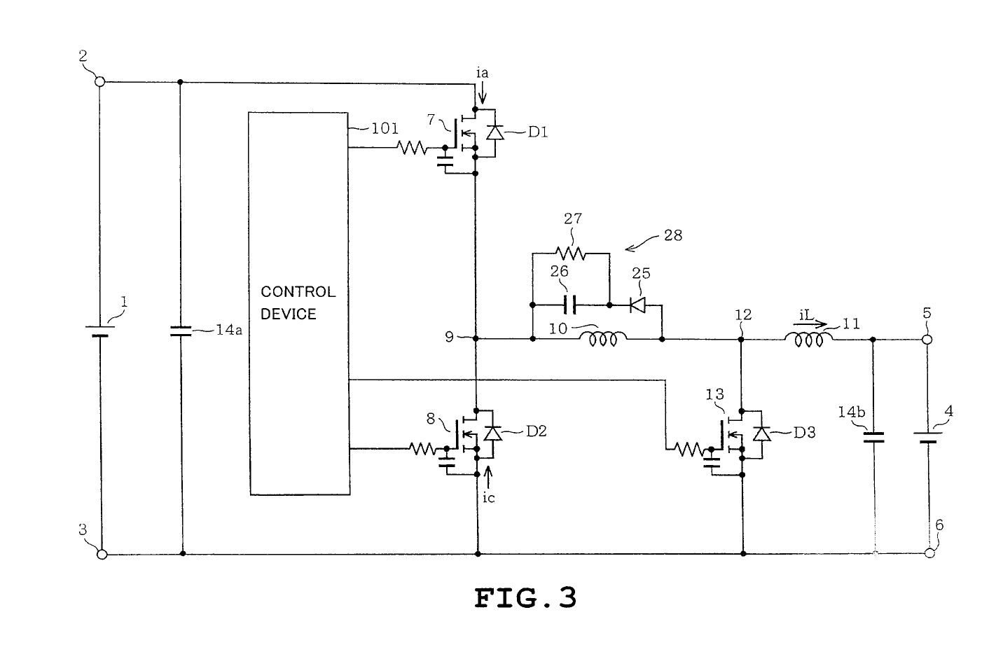

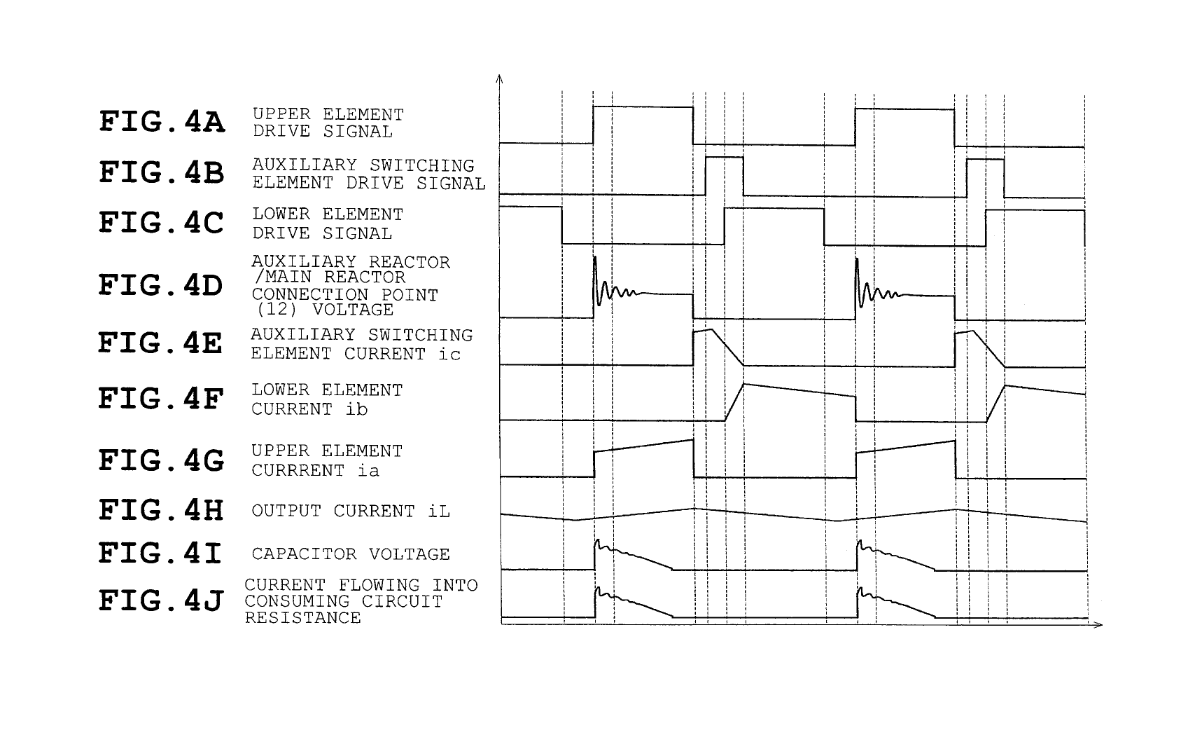

FIGS. 3 and 4A to 4J illustrate a second embodiment. In the second embodiment, identical or similar parts are labeled by the same reference symbols as those in the first embodiment and detailed description of these identical parts will be eliminated. Only the differences will be described in the following. A control device 101 as shown in FIG. 3 includes the SCU 15 and the gate drive circuits 16 to 18 shown in FIG. 1. In the second embodiment as shown in FIG. 3, the cathode of the diode 25 is not connected to the power supply of the gate drive circuit 16, but a resistance element 27 (a power consumption element) is connected in parallel to the capacitor 26. The diode 25, the capacitor 26 and the resistance element 27 configure a power consumption circuit 28.

The operation of the second embodiment will be described with reference to FIGS. 4A to 4J. In synchronization with turn-on of the first main switching element 7, current is flows into the auxiliary reactor 10 to generate electrical energy and ringing is caused at the common node 12, in the same manner as in the first embodiment. When the voltage due to the ringing rises to or above the power supply voltage of the gate drive circuit 16, current flows via the diode 25 to the parallel circuit of the capacitor 26 and the resistance element 27, so that the current is consumed by the resistance element 27 (see FIGS. 41 and 4J). Accordingly, since the electrical energy generated in the auxiliary reactor 10 is consumed at this time, a sufficient amount of residual electrical energy can be consumed thereafter when the auxiliary switching element 8 is turned on so that current ic is caused to flow.

In the above-described second embodiment, the power consumption circuit 28 is configured by connecting the resistance element 27 in parallel to the capacitor 26. Consequently, electrical energy generated in the auxiliary reactor 10 can be consumed by the resistance element 27.

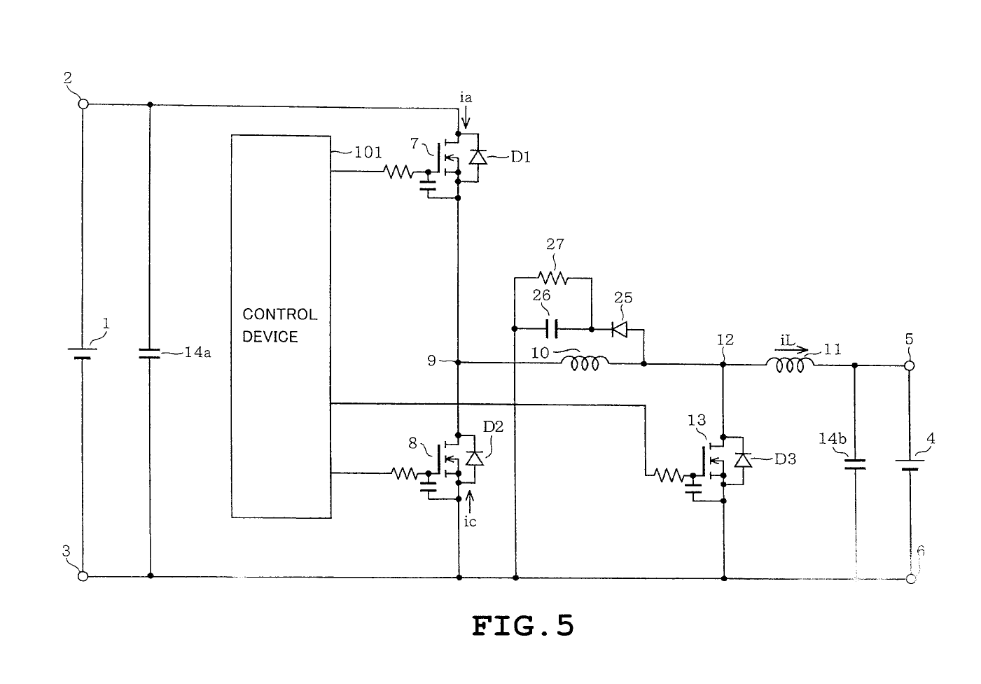

FIG. 5 illustrates a third embodiment. One sides of the capacitor 26 and the resistance element 27 are connected to the negative input terminal 3 (the negative output terminal 6) but not to the common node 9 in the third embodiment. In this circuit configuration, too, the electrical energy generated in the auxiliary reactor 10 is caused to flow as electrical current via the diode 25 into the parallel circuit of the capacitor 26 and the resistance element 27 to be consumed in the same manner as in the second embodiment. In this regard, however, the electrical energy is consumed at a higher speed in the third embodiment than in the second embodiment.

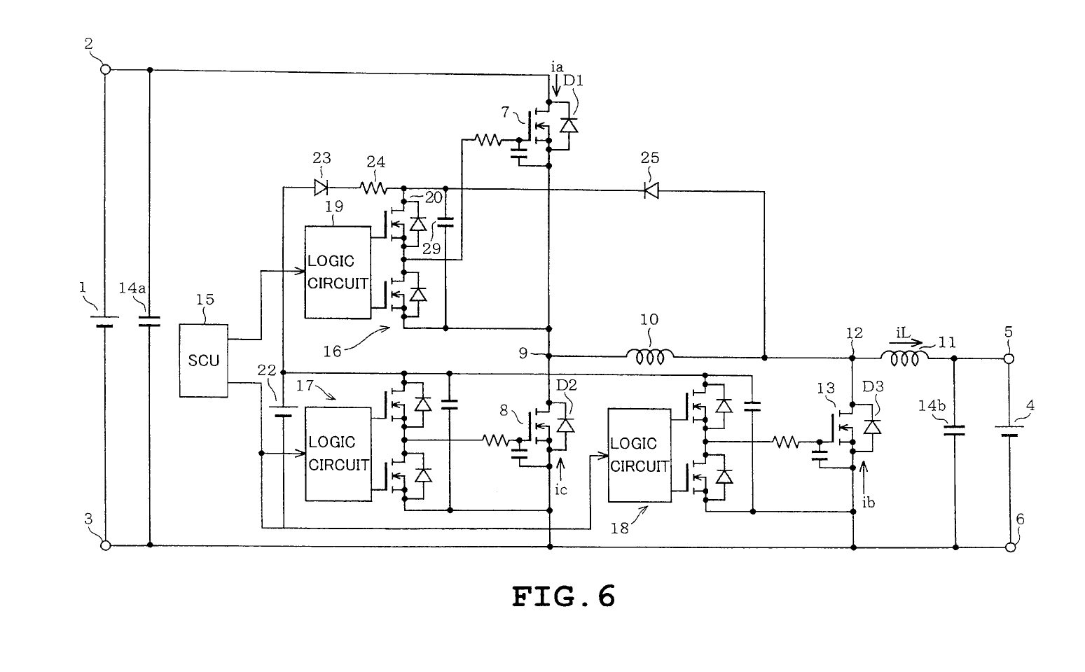

FIG. 6 illustrates a fourth embodiment. The capacitor 26 employed in the first embodiment is eliminated in the fourth embodiment, and a capacitor 29 common to the smoothing capacitor 21 is connected. The capacitor 29 has a capacitance which is set to be equal to or larger than the capacitance of capacitor 21 and to be equal to or below a parallel capacitance of the capacitors 21 and 26, for example. Thus, the capacitance corresponding to the capacitor 26 employed in the first embodiment is common to the smoothing capacitor 21 connected to the power supply of the gate drive circuit 16 in the fourth embodiment. This can reduce the number of circuit elements thereby to render the size of the DC-DC converter smaller.

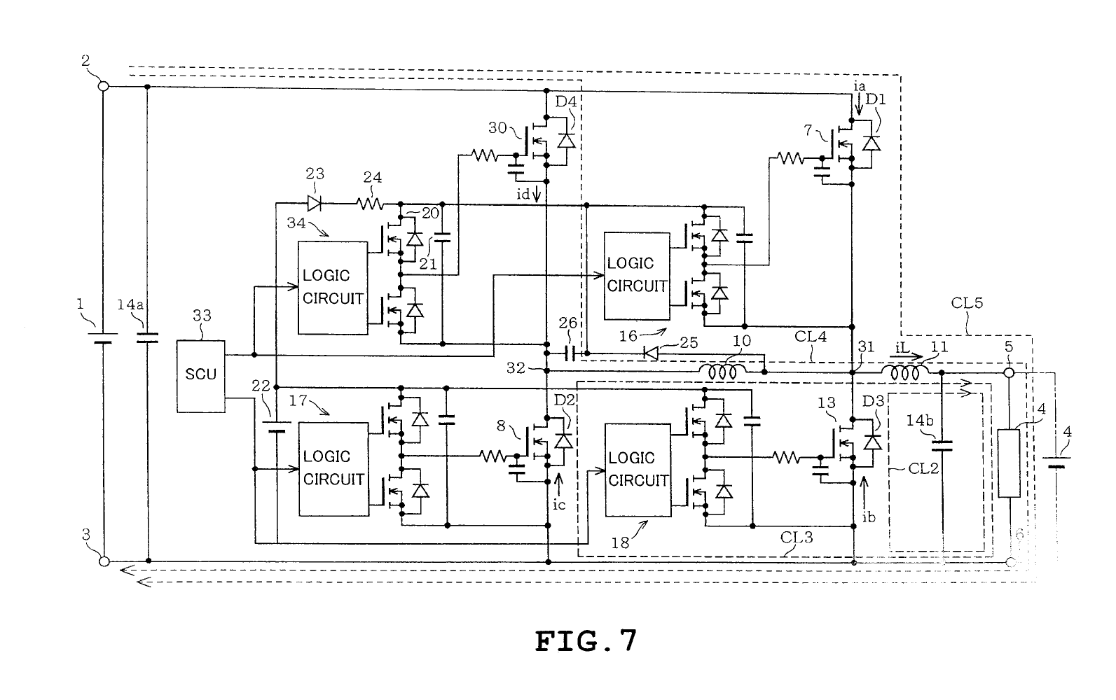

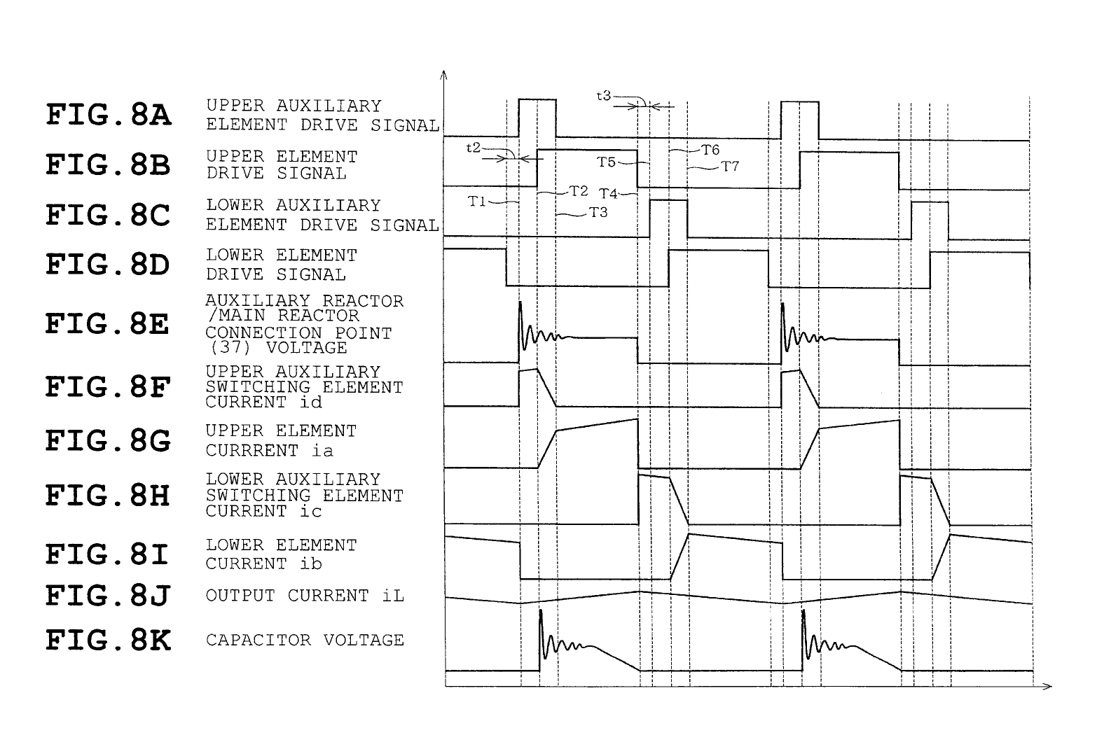

A fifth embodiment will be described with reference to FIGS. 7 and 8A to 8K. A series circuit of the first and second main switching elements 7 and 13 is connected between the positive and negative input terminals 2 and 3. The main reactor 11 is connected between the common node 31 of the main switching elements 7 and 13 and the positive output terminal 5. A series circuit of the first and second auxiliary switching elements 30 and 8 is connected between the positive and negative input terminals 2 and 3. The auxiliary reactor 10 is connected between the common node 31 and a common node 32 of the first and second auxiliary switching elements 30 and 8.

The first auxiliary switching element 30 is also an N-channel MOSFET, and a (parasitic) diode D4 is connected in reverse parallel to the switching element 30 between its drain and source. A switching control unit 33 is configured of a microcomputer and outputs gate control signals to the switching elements 7, 13, 18 and 8 thereby to on-off control the switching elements 7, 13, 18 and 8. Although a gate control signal is supplied via a gate drive circuit 34 to the first auxiliary switching element 30, the gate drive circuit 34 has the same configuration as the gate drive circuit 16. The auxiliary reactor 10 may have a quite smaller current capacitance than the main reactor 11.

The operation of the fifth embodiment will be described with reference to FIGS. 8A to 8K. The first and second switching elements 7 and 13 are on-off controlled so that on-periods do not overlap each other and so that the switching elements 7 and 13 have reverse phase modes, as shown in FIGS. 8B (an upper element drive signal) and 8D (a lower element drive signal). The first auxiliary switching element 30 is turned on prior to turn-on timing of the first main switching element 7 in a turn-off period of the second main switching element 13 and is turned off after turn-on of the first main switching element 7, as shown in FIG. 8A. This switching pattern is repeated.

The second auxiliary switching element 8 is turned on prior to turn-on timing of the second main switching element 13 in a turn-off period of the first main switching element 7 and is turned off after turn-on of the second main switching element 13, as shown in FIG. 8A. This switching pattern is repeated.

Reference symbol t2 in FIGS. 8A to 8D designates dead time inserted between turn-off of the second main switching element 13 and turn-on of the first auxiliary switching element 30. Reference symbol t3 in FIGS. 8A to 8K designates dead time inserted between turn-off of the first main switching element 7 and turn-on of the second auxiliary switching element 8.

When the first auxiliary switching element 30 is turned on at time T1 in FIGS. 8A to 8K, the closed loop CL4 is formed with the result that current flows into the load 4 through the positive input terminal 2, the first auxiliary switching element 30, the auxiliary reactor 10 and the main reactor 11. When the first main switching element 7 is subsequently turned on at time T2, the closed loop CL5 is formed with the result that current flows into the load 4 through the positive input terminal 2, the first main switching element 7 and the main reactor 11. Symbol indicative of a battery in FIG. 7 shows a case where the load 4 is the battery.

The closed loop CL3 is formed in the same manner as in the first embodiment when the second auxiliary switching element 8 is turned on at time T5 after turn-off of the first main switching element 7 at time T4. Electrical energy stored in the auxiliary reactor 10 is then discharged through the main reactor 11 to the load 4 side by the on-off operation of the first auxiliary switching element 30 thereby to be used as consumption energy of the load 4. When the second main switching element 13 is turned on at immediate time T6, the closed loop CL2 is formed in the same manner as in the first embodiment, so that electrical energy stored in the main reactor 11 is discharged to the load 4.

FIG. 8J shows current iL flowing through the main reactor 11 in the aforementioned operation. FIG. 8F shows current id flowing through the first auxiliary switching element 30, that is, through the auxiliary reactor 10. FIG. 8G shows current is flowing through the first main switching element 7. FIG. 8H shows current is flowing through the second auxiliary switching element 8. FIG. 8I shows current ib flowing through the second main switching element 13. As understood from the foregoing, energization of the main reactor 11 starts through the first auxiliary switching element 30 turned on at time T1 prior to turn-on of the first main switching element 7. Recovery current is generated at time T1 which flows through the diodes D4 and D3 in the reverse direction. However, the recovery current does not become a short-circuit current since the recovery current flows through the auxiliary reactor 10.

The first and second main switching elements 7 and 13 provided with the respective diodes D1 and D3 form a series circuit. In this series circuit, the first auxiliary switching element 30 is turned on in a period between time T1 and time T2, in which period both switching elements 7 and 13 are turned off. Accordingly, no recovery current flowing through the diodes D1 and D3 is generated. The added first and second auxiliary switching elements 30 and 8 also form a series circuit. Regarding the diodes D4 and D2 in this series circuit, current iL due to back electromotive force of the main reactor 11 flows through the closed loop CL3 and the diode D2 in a period between time T4 and time T5, in which period both switching elements 30 and 8 are turned off. Accordingly, no recovery current flows.

In the fifth embodiment, the first auxiliary switching element 30 is provided which is turned on prior to turn-on of the first main switching element 7. Energization of the main reactor 11 is divided into a period of time in which current flows through the auxiliary reactor 10 and another period of time in which current flows through the first main switching element 7 without through the auxiliary reactor 10.

In the fifth embodiment, too, a series circuit of the diode 25 and the capacitor 26 is connected in parallel to the auxiliary reactor 10. Consequently, in synchronization with turn-on of the first main switching element 7, current is flows into the auxiliary reactor 10 in the same manner as in the first embodiment, with the result that electrical energy is generated. When voltage due to ringing produced at the common node 31 rises above the power supply voltage of the gate drive circuit 34, current flows through the diode 25 to the power supply side, resulting in a regenerative action. Accordingly, a sufficient amount of residual electrical energy can be consumed when current is turning on the auxiliary switching element 8 thereafter flows.

The configuration of the fifth embodiment can be used as a voltage boosting power supply device for an electric vehicle as follows. More specifically, a 12V low-voltage battery 4 as the load is connected so that a positive electrode thereof serves as the DC positive output terminal 5. The low-voltage battery 4 is a power supply for low-voltage electrical equipment of the vehicle. On the other hand, the DC power supply 1 serves as a 400-V high-voltage battery for driving assist motors of the electric vehicle.

The electric vehicle requires an urgent action that the voltage of the low-voltage battery 4 needs to be boosted up to 400 V and to replenish the high-voltage battery 1 with power. This urgent action can be realized in the aforementioned connecting configuration when the first and second main switching elements 7 and 13 are on-off controlled in a mode of on-duty exceeding 50%. The on-off operation of the first and second main switching elements 7 and 13 is accompanied by the operation of the first and second auxiliary switching elements 30 and 8 as described above.

In the above-described fifth embodiment, the first and second switching elements 7 and 13 are series-connected between the positive input terminal 2 and the negative input terminal 3. The main reactor 11 is connected between the common node 31 of both main switching elements 7 and 13 and the positive output terminal 5. The first and second auxiliary switching elements 8 and 30 are series-connected between the positive input terminal 2 and the negative input terminal 3. The auxiliary reactor 10 is connected between the common node 31 and the common node 32 of the first and second auxiliary switching elements 8 and 30. The series circuit of the diode 25 and the capacitor 26 is connected in parallel to the auxiliary reactor 10. The cathode of the diode 25 is connected to the power supply of the gate drive circuit 34.

Accordingly, in synchronization with turn-on of the first main switching element 7, the electrical energy generated by the current is flowing into the auxiliary reactor 10 can be regenerated at the power supply side of the gate drive circuit 34 to be consumed. Consequently, when the auxiliary switching element 8 is thereafter turned on so that current is flows, a sufficient amount of residual electrical energy in the auxiliary reactor 10 can be consumed. Further, the DC-DC converter can be provided in which a simple and cost-effective configuration of addition of the auxiliary reactor 10 with small inductance and small electrical capacity and the auxiliary switching elements 8 and 30 can reliably suppress short-circuit current due to recovery current, and the suppressed component is available as power to be consumed.

In a modified form, for example, the cathode of the diode 25 may be connected to the positive input terminal 2 in the first embodiment. In this case, only the power exceeding the voltage of the DC power supply 1 out of the surge voltage due to back electromotive force generated in the auxiliary reactor 10 is discharged to the smoothing capacitor 14a for the regenerative action.

The configuration of each one of the second to fourth embodiments may be applied to the configuration of the fifth embodiment.

IGBTs or power transistors may be used as the switching elements.

While certain embodiments have been described, these embodiments have been presented byway of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A DC-DC converter comprising:
a main reactor disposed in a main energization path extending from a DC voltage input terminal to a DC voltage output terminal;
a first main switching element disposed in the main energization path and on-off controlled to cause current flowing through the main reactor to intermittently flow;
a second main switching element forming a discharge loop configured to discharge electrical energy stored in the main reactors to the DC voltage output terminal side;
an auxiliary reactor disposed between the first main switching element and the main reactor in the main energization path;
an auxiliary switching element discharging electrical energy stored in the auxiliary and main reactors through the main reactor to the DC voltage output terminal side in the main energization path;
a plurality of diodes connected reversely in parallel to the respective main switching elements and the auxiliary switching element; and
a series circuit connected in parallel to the auxiliary reactor and including a diode with an anode located at the main reactor side and a capacitor.

2. A DC-DC converter comprising:
a positive input terminal and a negative input terminal;
a positive output terminal and a negative output terminal;
a first main switching element and an auxiliary switching element connected in series to each other between the positive input terminal and the negative input terminal and located at the positive and negative sides respectively;
a main reactor having one of two ends connected to the positive output terminal and an auxiliary reactor having one of two ends connected to the other end of the main reactor, the other end of the auxiliary reactor being connected to a common node of both switching elements;
a second main switching element connected between a common node of the reactors and the negative output terminal;
a plurality of diodes connected reversely in parallel to the respective main switching elements and the auxiliary switching element; and
a series circuit connected in parallel to the auxiliary reactor and including a diode with an anode located at the main reactor side and a capacitor.

3. The DC-DC converter according to claim 1, wherein the auxiliary switching element is turned on prior to turn-on of the second main switching element and turned off prior to turn-off of the second main switching element.

4. The DC-DC converter according to claim 2, wherein the auxiliary switching element is turned on prior to turn-on of the second main switching element and turned off prior to turn-off of the second main switching element.

5. A DC-DC converter comprising:
a positive input terminal and a negative input terminal;
a positive output terminal and a negative output terminal;
a first and a second main switching elements series-connected between the positive input terminal and the negative input terminal;
a main reactor connected between a common node of both main switching elements and the positive output terminal;
a first and a second auxiliary switching elements series connected between the positive input terminal and the negative input terminal;
an auxiliary reactor connected between a common node of the first and second main switching elements and a common node of the first and second auxiliary switching elements;
a plurality of diodes connected reversely in parallel to the respective main switching elements and the respective auxiliary switching elements; and
a series circuit connected in parallel to the auxiliary reactor and including a diode with an anode located at the main reactor side and a capacitor.

6. The DC-DC converter according to claim 5, wherein the first and second auxiliary switching elements are turned on prior to turn-on of the first and second main switching elements and turned off prior to turn-off of the first and second main switching elements.

7. The DC-DC converter according to claim 1, wherein the series circuit has a common node connected to a DC voltage source or a power supply of a drive circuit driving the first main switching element.

8. The DC-DC converter according to claim 2, wherein the series circuit has a common node connected to a DC voltage source or a power supply of a drive circuit driving the first main switching element.

9. The DC-DC converter according to claim 5, wherein the series circuit has a common node connected to a DC voltage source or a power supply of a drive circuit driving the first main switching element.

10. The DC-DC converter according to claim 7, wherein the capacitor is commonly used as a smoothing capacitor of the power supply.

11. The DC-DC converter according to claim 8, wherein the capacitor is commonly used as a smoothing capacitor of the power supply.

12. The DC-DC converter according to claim 9, wherein the capacitor is commonly used as a smoothing capacitor of the power supply.

13. The DC-DC converter according to claim 1, further comprising a power consumption element connected in parallel to the capacitor.

14. The DC-DC converter according to claim 2, further comprising a power consumption element connected in parallel to the capacitor.

15. The DC-DC converter according to claim 5, further comprising a power consumption element connected in parallel to the capacitor.

16. A DC-DC converter comprising:
a main reactor disposed in a main energization path extending from a DC voltage input terminal to a DC voltage output terminal;
a first main switching element disposed in the main energization path and on-off controlled to cause current flowing through the main reactor to intermittently flow;
a second main switching element forming a discharge loop configured to discharge electrical energy stored in the main reactor to the DC voltage output terminal side;
an auxiliary reactor disposed between the first main switching element and the main reactor in the main energization path;
an auxiliary switching element discharging electrical energy stored in the auxiliary and main reactors through the main reactor to the DC voltage output terminal side in the main energization path;
a plurality of diodes connected reversely in parallel to the respective main switching elements and the auxiliary switching element; and
a power consumption circuit series-connected between a common node of the auxiliary reactor and the main reactor and ground and including a diode with an anode located at the common node side, a capacitor and a power consumption element connected in parallel to the capacitor.

17. The DC-DC converter according to claim 1, wherein the auxiliary reactor has an electrical capacity set to be smaller than an electrical capacity of the main reactor.

18. The DC-DC converter according to claim 2, wherein the auxiliary reactor has an electrical capacity set to be smaller than an electrical capacity of the main reactor.

19. The DC-DC converter according to claim 5, wherein the auxiliary reactor has an electrical capacity set to be smaller than an electrical capacity of the main reactor.

20. The DC-DC converter according to claim 16, wherein the auxiliary reactor has an electrical capacity set to be smaller than an electrical capacity of the main reactor.

21. The DC-DC converter according to claim 1, wherein the auxiliary switching element has an electrical capacity set to be smaller than an electrical capacity of the main switching element.

22. The DC-DC converter according to claim 2, wherein the auxiliary switching element has an electrical capacity set to be smaller than an electrical capacity of the main switching element.

23. The DC-DC converter according to claim 5, wherein the auxiliary switching element has an electrical capacity set to be smaller than an electrical capacity of the main switching element.

24. The DC-DC converter according to claim 16, wherein the auxiliary switching element has an electrical capacity set to be smaller than an electrical capacity of the main switching element.
